(19) United States
(12) Patent Application Publication
(10) Pub. No.: US 2025/0103821 A1
(43) Pub. Date: Mar. 27, 2025

(54) INTERACTIVE QUERY FACILITATION

(71) Applicant: Zoom Video Communications, Inc., San Jose, CA (US)

(72) Inventors: Wei Ji, San Jose, CA (US); Bilung Lee, San Jose, CA (US); Vijay Venkataswamy Parthasarathy, San Jose, CA (US); Renjie Tao, Santa Clara, CA (US)

(21) Appl. No.: 18/372,434

(22) Filed: Sep. 25, 2023

(51) Int. Cl. G06F 40/35; G06F 40/40; H04L 51/02; H04L 51/216

(52) U.S. Cl. CPC G06F 40/35; G06F 40/40; H04L 51/02; H04L 51/216

(57) ABSTRACT

Example methods and systems for facilitating queries about a virtual communication session are provided. A communication platform receives an initial query about the virtual communication session from a user. The communication platform accesses virtual communication data associated with a virtual communication session. The communication platform generates an initial response to the initial query based on the virtual communication data using a first pre-trained generative artificial intelligence (AI) model. The communication platform generates a first set of follow-up queries based on the initial response using a second pre-trained generative AI model. The communication platform receives a selection of a first follow-up query out of the first set of follow-up queries. The communication platform provides a first response to the first follow-up query using the first pre-trained generative AI model.

### FIELD

The present application generally relates to virtual communication and more specifically relates to interactive query facilitation.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides videoconferencing and chat functionality to various client devices;

FIG. 2 shows an example system in which a chat and video conference provider provides videoconferencing and chat functionality to various client device;

FIG. 3 shows an example system that can establish a virtual communication session;

FIG. 4 shows an example system that is configured to facilitate interactive queries associated with a virtual communication session;

FIG. 5 shows an example GUI displaying a consent authorization request for accessing personal data;

FIG. 6 shows an example GUI of an interactive query session;

FIG. 7 shows an example method for interactive query facilitation; and

FIG. 8 shows an example computing device suitable for use in example systems or methods for interactive query facilitation, according to certain examples.

### DETAILED DESCRIPTION

Examples are described herein in the context of interactive query facilitation. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Virtual communications, such as video conferences, online chats, or any other online interactions, become important ways for users to share information. Users may discuss various aspects related to a project, a deal, or any suitable subjects. Some users may join a virtual meeting late, or not be able to attend a virtual meeting at all, but would still like to learn the missed information discussed during the virtual meeting. It may take a lot of time for the users to review and sift useful information through the chat history or the entire recording of a video conference. Still, the user may not collect or find all the information interesting to the user.

To facilitate users to obtain relevant information from a missed virtual meeting, it is desirable for a communication platform to automatically answer user queries and prompt follow-up queries. For example, the communication platform provides an answer generation engine for automatically answering user queries and a query generation engine for automatically generating follow-up queries.

In an example, a communication platform establishes a video conference between two or more users. The two or more users join the video conference via client devices installed with a communication application provided by the communication platform. A user may join the video conference late, for example 20 minutes late. In other situations, a user may not be able to attend the video conference at all, but a recording of the video conference can be created with all attending users' consent and provided to the absent user.

The user can ask questions about the video conference via an interactive graphical user interface (GUI) window, for example a chat window on a client application provided by the communication platform, during or after the video conference. The communication platform can generate answers to user questions and further prompt follow-up questions.

The communication platform can train a first generative artificial intelligence (AI) model for generating answers and a second generative AI model for generating follow-up questions. For example, the first AI model for answer generation can be trained using a set of communication data. The communication data can be a set of virtual communication data collected with informed user consent with personal identifiable information or confidential information removed or redacted, or a set of mockup communication data. A set of labeled questions and answers can be created by an operator based on the set of communication data. The set of labeled questions and answers are used as training output and the set of communication data are used as training input. The communication platform can also train the AI model for query (question) generation based on the set of communication data. A set of labeled questions, which can be part of the set of labeled questions and answers used for training the first AI model for answer generation, can be created by an operator based on the set of communication data. The set of labeled questions are used as training output and the set of communication data are used as training input.

When a user types a query or selects an automatically generated query, the pre-trained generative AI model for answer generation generates an answer to the query based on video conference data associated with the video conference. The pre-trained generative AI model can access the video conference data with informed user consent. A user may provide feedback about the generated answer, for example, helpful or not helpful.

After an answer to a query is provided to user, the pre-trained generative AI model for query generation may generate one or more queries for the user to select as a follow-up query. The one or more queries can be generated based on the answer to the last user query.

A user can select a query from the one or more automatically generated user queries. Alternatively, the user can type a different query. The user selection or non-selection of the automatically generated queries can be considered as user feedback. If the user selects one of the generated queries, the selected query can be added, for example with user consent, to the labeled queries to refine or enrich the training dataset, which can be used to fine-tune or retrain the generative AI model for query generation. If the user does not select any of the generated queries, certain labeled queries that are similar to these nonelected queries may be limited or removed from the training dataset. In some examples, the GUI window may include a button for regenerating queries. When the regeneration button is activated, the query generation engine can generate additional queries for the user to select. Powered by generative AI models for answer generation and query generation, a user can ask multiple questions which can be answered in a chat format until the user gets all the information the user is interested in.

Thus, this example facilitates querying a virtual communication session. During or after a virtual communication session, such as a video conference or a chat session, an authorized user can obtain information discussed during the virtual communication session via interactive queries. A user provides the initial query, and an answer to the initial query can be generated using generative AI technology. Subsequent queries can be automatically generated using generative AI technology and provided to the user for selection, and selected queries can be answered automatically. The user can obtain relevant information via such an interaction. The interactive query facilitation saves user time and provides relevant information to the user about a virtual communication by automatic answer generation and follow-up query suggestion.

Applicant's goal is to invest in AI-driven innovation that enhances user experience and productivity while prioritizing trust, safety, and privacy. Applicant does not use any customer audio, video, chat, screen-sharing, attachments, or other communications-like customer content (such as poll results, whiteboards, or reactions) to train Applicant's or third-party artificial intelligence models. Additionally, AI-enabled features are turned off by default-account owners and administrators control whether to enable these AI features for their accounts. Applicant provides admins and users control and visibility when AI features are being used or activated. By putting its customers' privacy needs first, Applicant is taking a leadership position, enabling its customers to use AI-powered tools and its capabilities with confidence.

This illustrative example is given to introduce the reader to the general subject matter discussed herein and the disclosure is not limited to this example. The following sections describe various additional non-limiting examples and examples of interactive query facilitation.

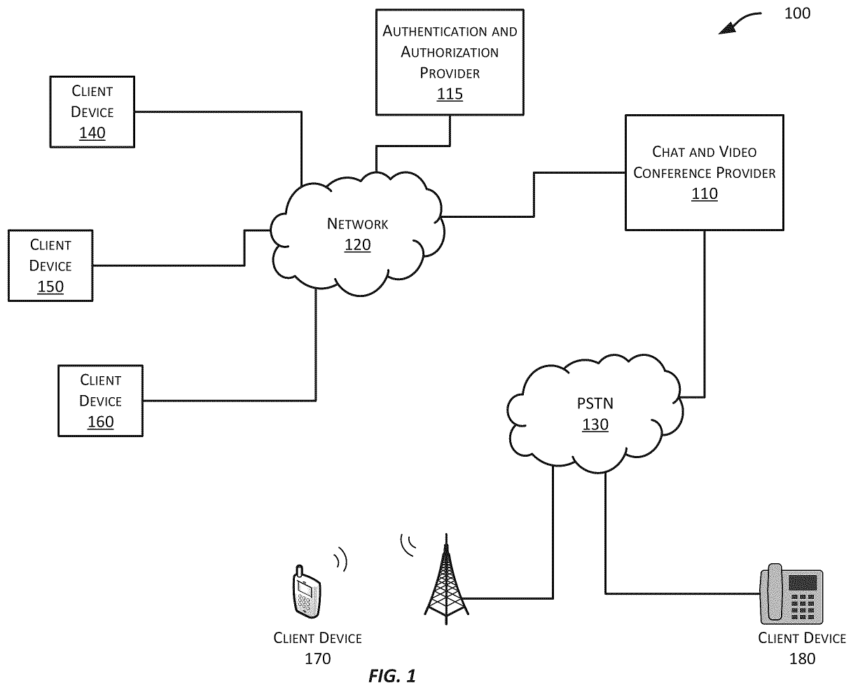

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

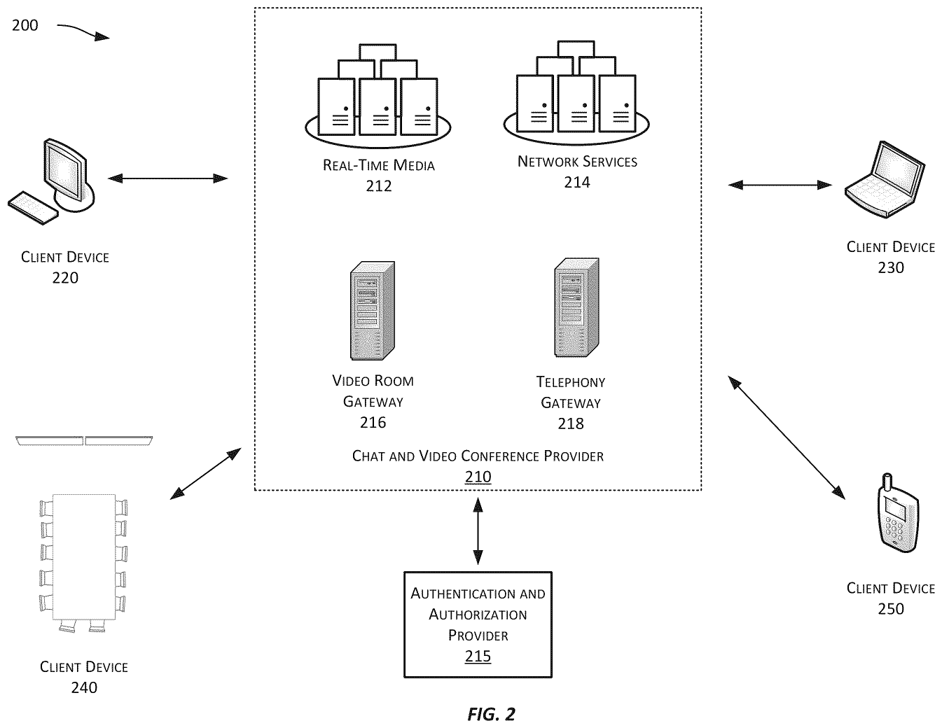

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices, etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O) as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

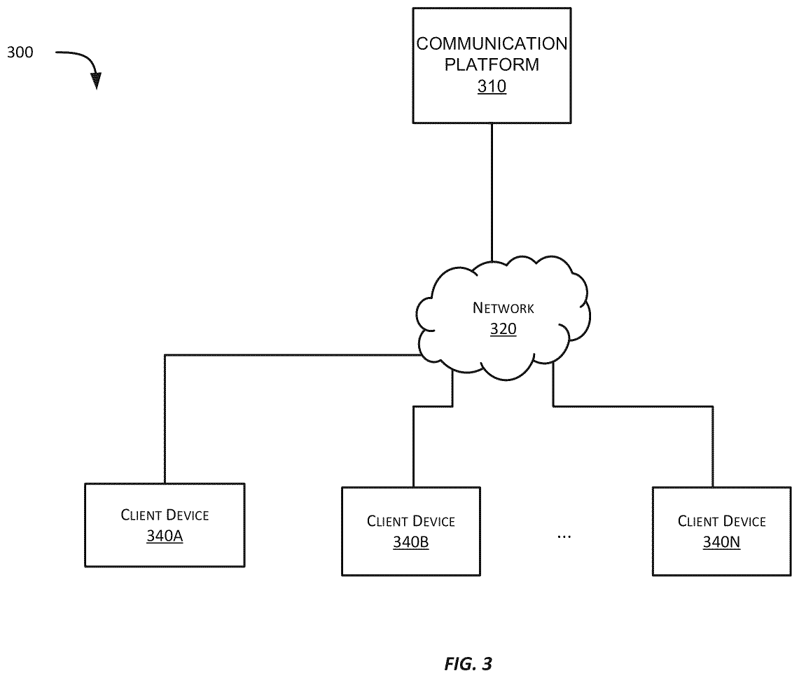

Referring now to FIG. 3, FIG. 3 shows an example system 300 that can establish a virtual communication session. In this example system 300, a communication platform 310 and a number of client device 340A-340N (which may be referred to herein individually as a client device 340 or collectively as the client devices 340) are connected via a network 320. The communication platform 310 can be the chat and video conference provider 110 in FIG. 1 or the chat and video conference provider 210 in FIG. 2. The network 320 can be the internet or any suitable communications network or combination of communications network may be employed, including LANs (e.g., within a corporate private LAN), WANs, MANs, cellular network (e.g., 3G, 4G, 4G LTE, 5G, etc.), or any combination of these.

The client devices 340 can be any suitable computing or communications device. The client device 340 can be a client device (e.g., 140, 150, 160, or 170) in FIG. 1 or a client device (e.g., 220, 230, or 250) in FIG. 2. For example, client devices 340 may be desktop computers, laptop computers, tablets, smart phones having processors and computer-readable media, connected to the communication platform 310 using the internet or other suitable computer network. The client devices 340 have communication software installed to enable them to connect to the communication platform 310 for chats, video conferences, emails, and any other suitable communications. For example, during a chat session, a user associated a client device (e.g., client device 340A) can interact with other users associated with other client devices (e.g., client device 340B-340N) via the communication platform 310 by sending and receiving chat messages, and reacting to received chat messages.

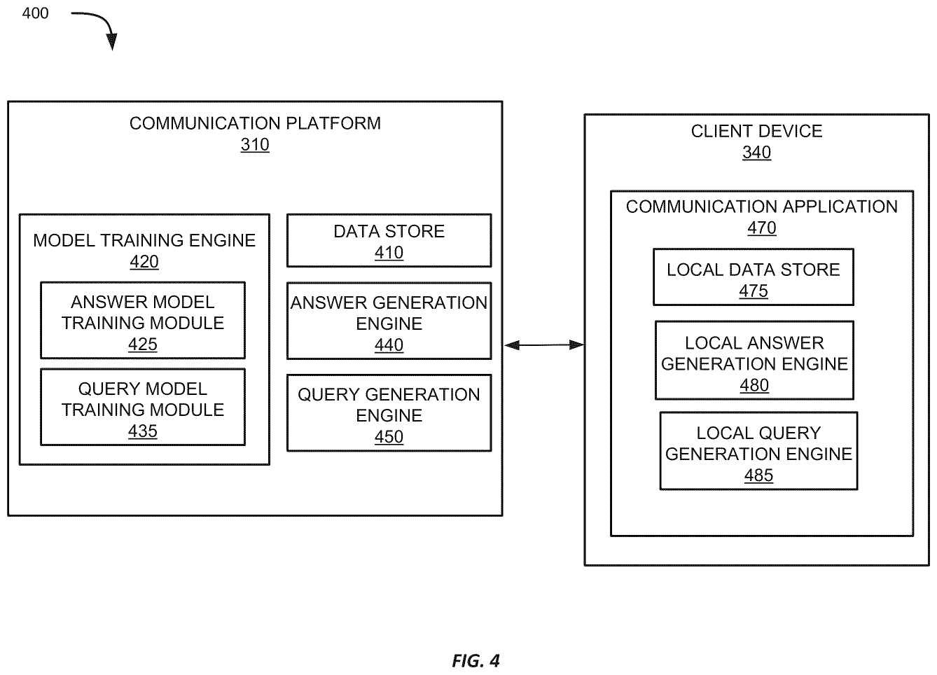

Now referring to FIG. 4, FIG. 4 shows an example system 400 that is configured to facilitate interactive queries associated with a virtual communication session. The communication platform 310 is in network communication with a client device 340. The client device 340 is installed with a communication application 470 provided by the communication platform 310.

The communication platform 310 includes a data store 410, a model training engine 420, an answer generation engine 440, and a query generation engine 450. The data store 410 stores virtual communication data and metadata associated with different virtual communication sessions established on the communication platform 310. The virtual communication sessions can be video conference sessions, chat sessions, or email threads. The virtual communication data associated with a video conference session can include one or more of a recording of the video conference session, a transcript of the recording, and shared documents during the video conference session. The metadata associated with the video conference session can include one or more of a title of the video conference session, a start and end time of the video conference session, a description of the video conference session, an agenda of the video conference session, and participant data associated with the video conference session. The virtual communication data associated with a chat session can include chat messages. The chat messages can be text-based messages, hyperlinks, or documents. The metadata associated with the chat session can include one or more of a topic of the chat session, a start and end time of the chat session, the participant data associated with the chat session. The virtual communication data associated with an email thread can include the email content in the email thread. The metadata associated with the email thread can include one or more of a subject of the email thread, a send time of an email in the email thread, and sender and recipient data associated with an email in the email thread.

The model training engine 420 is configured to train the generative AI models used in the answer generation engine 440 and the query generation engine 450. The model training engine 420 can include an answer model training module 425 and a query model training module 435. The answer model training module 425 is configured to train a first generative AI model for answer generation. The answer model training module 425 can train the first generative AI model for answer generation based on a set of communication data. The communication data can be a set of virtual communication data collected with informed user consent, for example video conference transcripts or chat messages. The virtual communication data can be de-identified by removing personal identifiable information. Sensitive or confidential information can be redacted. Alternatively, or additionally, the set of communication data includes a set of mockup communication data, such as publicly available training datasets that include different types of communication data. A set of labeled questions and answers can be created by an operator based on the set of communication data. The set of labeled questions and answers are used as training output and the set of communication data are used as training input.

The query model training module 435 is configured to train a second generative AI model for query generation. The query model training module 435 can train the second generative AI model for query generation based on a set of communication data. A set of labeled questions can be created by an operator based on the set of communication data. The set of labeled questions are used as training output and the set of communication data are used as training input. In some examples, the set of communication data used for training the first generative AI model for answer generation can be used as training input for training the second generative AI model for query generation. Similarly, the labeled questions created based on the set of communication data for training the first generative AI model for answer generation can be used as training output for training the second generative AI model for query generation.

The answer generation engine 440 is configured to generate an answer to a user query based on the virtual communication data associated with a virtual communication session. The answer generation engine 440 can implement the first generative AI model pre-trained by the model training engine 420 to generate answers to user queries. A user can type in a query or select an automatically generated query via a communication application 470 (which will be described later) installed on a client device 340 and provided by the communication platform 310. The answer generation engine 440 can an answer to the query based on virtual communication data. The answer can be provided to the user via the communication application 470. The user may provide feedback about the generated answer via the communication application.

The query generation engine 450 is configured to generate one or more queries based on an answer to a previous query associated with the virtual communication session. The query generation engine 450 can implement the second generative AI model pre-trained by the model training engine 420 to generate follow-up queries based on the answer. In some examples, other data is also used by the second pre-trained generative AI model, for example, previous entered or selected queries and the virtual communication data. After the answer generation engine 440 provides an answer to a user query, either a user-typed query or a user-selected query, the query generation engine 450 may generate one or more queries for the user to select as a follow-up query based on the answer to the last user query. The one of more queries can be provided to the user via the communication application 470.

A user can select a query from the one or more automatically generated user queries. Alternatively, the user can type a different query. The user selection or non-selection of the automatically generated queries can be provided to the second generative AI model for query generation. If the user selects one of the generated queries, the selected query can be added with informed user consent, to the labeled queries to refine or enrich the training dataset (if similar queries are not there yet) for fine-tuning or retraining the second generative AI model for query generation. If the user does not select any of the generated queries, labeled queries that are similar to these nonelected queries may be limited or removed from the training dataset. In some examples, the query generation engine 450 can regenerate queries. For example, when a user activates a regenerate button provided on a GUI of the communication application 470, the query generation engine 450 can generate additional queries for the user to select.

In some examples, one query facilitation engine (not shown) implementing one generative AI model can be configured to generate both answers to queries and follow-up queries. For example, if a query is entered, the generative AI model generates an answer to the query. If an answer is generated and provided to the user, the generative AI model then generates follow-up queries based on the generated answer or other data (e.g., previous queries and the virtual communication data).

The communication application 470 installed on the client device 340 can include a local data store 475, a local answer generation engine 480, and a local query generation engine 485. The local data store 475 can store virtual communication data associated with virtual communication sessions hosted or joined by the local user associated with the client device 340. The local answer generation engine 480 can be configured to generate an answer to a user query based on virtual communication data stored in the local data store 475 or other accessible data, similar to the answer generation engine 440 as described above. The local answer generation engine 480 can implement a generative AI model for answer generation trained by the model training engine 420 on the communication platform 310. The local query generation engine 485 can be configured to generate follow-up queries based on an answer to a previous query, similar to the query generation engine 450 as described above. The local query generation engine 485 can implement a generative AI model trained by the model training engine 420 on the communication platform 310. In some examples, one local query facilitation engine (not shown) implementing one generative AI model can be configured to generate both answers to queries and follow-up queries, similar to the query facilitation engine described above.

The communication application 470 provides a GUI for the virtual communication session and a GUI for an interactive query session associated with the virtual communication session. In some examples, the GUI for the interactive query session is a GUI element within the GUI for the virtual communication session. In some examples, the GUI for the interactive query session is a separate tab on the GUI of the communication application 470, where a user can query about different virtual communication sessions. The GUI for the interactive query session can be a chat window. Queries and answers can be displayed as chat messages.

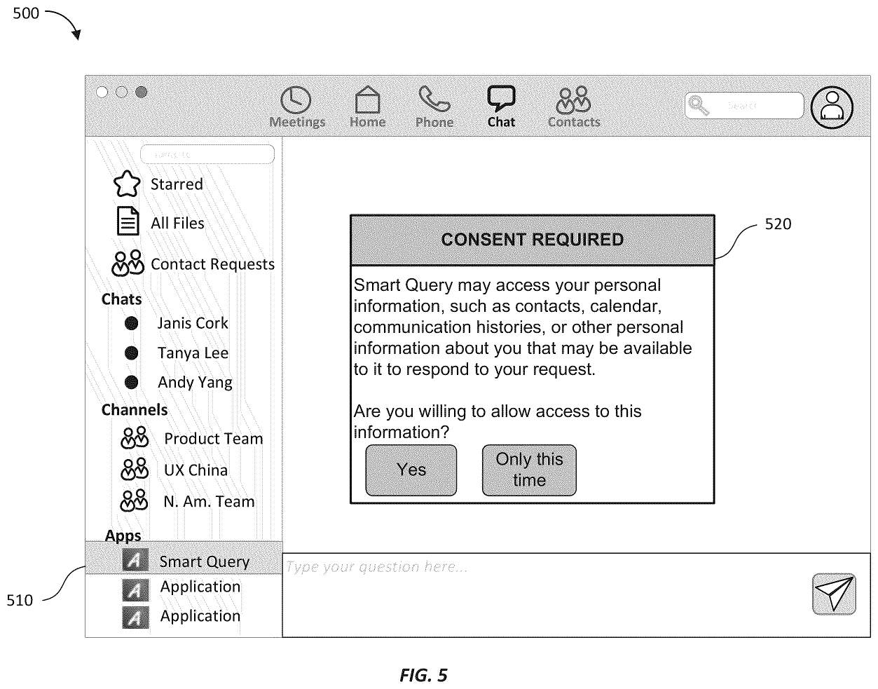

Now referring to FIG. 5, FIG. 5 shows an example GUI 500 displaying a consent authorization request for accessing personal data. The example GUI 500 displays a chat panel. The chat panel includes certain integrated applications, such as a smart query application 510. The “smart query” application 510 provides application program interface (API) to the answer generation engine 440 and the query generation engine 450 on the communication platform 310. A user can query certain information in certain chat channels or chat sessions using the smart query application 510. When a user clicks or touches the “smart query” application 510 displayed in the example GUI 500, a consent authorization is then displayed in a GUI element 520 for the user to interact with. The consent authorization informs the user that the “smart query” feature may involve the communication platform 310 accessing multiple different types of information, which may be personal to the user. The user can decide whether to grant permission to the communication platform 310 generally or only for this request. Alternatively, the user can decline to provide permission, which may prevent the communication platform 310 from accessing the user's personal information to facilitate user queries.

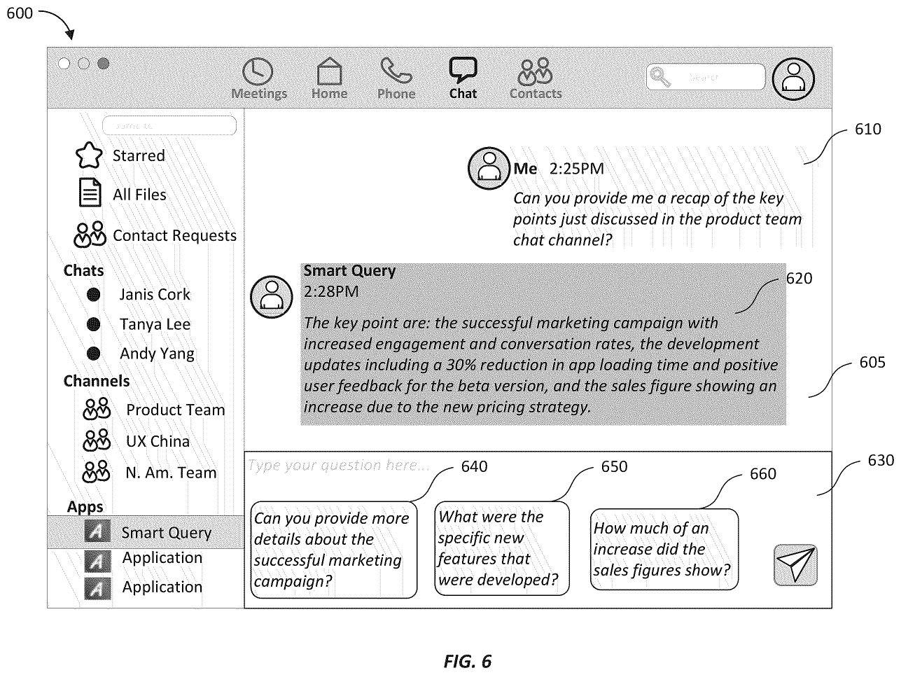

Now referring to FIG. 6, FIG. 6 shows an example GUI 600 of an interactive query session. The example GUI 600 includes a query dialogue window 605 displaying an initial user query 610 and an initial response 620 to the initial user query 610. The initial user query 610 is entered by a user from the query entering panel 630. The initial response 620 is generated and provided by the answer generation engine 440 on the communication platform 310. The query entering panel 630 displays three follow-up queries 640, 650, and 660, which are automatically generated by the query generation engine 450 based on the initial response 620 to the initial user query 610. The user may select one of the follow-up queries as the next query. Alternatively, the user can type in a different query in the query entering panel 630. When the user enters a follow-up query, either selected from the auto-generated queries (e.g., 640, 650, 660) or a different typed-in query, to the query dialogue window 605, the answer generation engine 440 on the communication platform 310 can generate a response to the follow-up query. This way, the user can be prompted with automatically generated queries for selection to obtain automatically generated answers in an interactive manner to obtain relevant information.

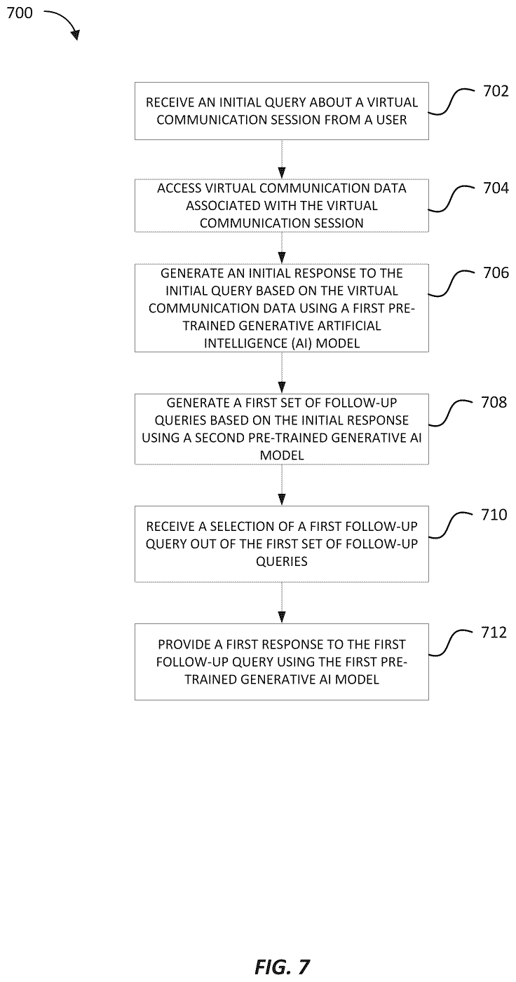

Now referring to FIG. 7, FIG. 7 shows an example method 700 for interactive query facilitation. The example method 700 will be discussed with respect to the system 400 shown in FIG. 4; however, any suitable system for interactive query facilitation may be used.

At block 702, a communication platform 310 receives an initial query about a virtual communication session from a user. The user may have joined the virtual communication session late or did not attend the virtual communication session. The user can type in an initial query about the virtual communication session via a GUI of a communication application 470 installed on a client device 340 and provided by the communication platform 310. The communication platform 310 receives the initial query about the virtual communication session via the GUI of the communication application 470 installed on client device 340 associated with the user.

At block 704, the communication platform 310 accesses virtual communication data associated with the virtual communication session. If the virtual communication session is an online chat session, the virtual communication data can include multiple chat messages in the online chat session. If the virtual communication session is a video conference, the virtual communication data can include a transcript for the video conference, a recording of the video conference, or shared documents during the video conference. If the virtual communication session is an email thread, the virtual communication data can include a sequence of emails. The virtual communication data can be stored in a data store 410 on the communication platform 310. In some examples, the communication platform 310 determines that the user is an authorized user for accessing the virtual communication data. In some examples, the answer generation engine 440 and the query generation engine 450 on the communication platform 310 need to get the authorized user's permission to access the virtual communication data to generate the initial response and follow-up queries, as will be described below.

At block 706, the communication platform 310 generates an initial response to the initial query based on the virtual communication data using a first pre-trained generative artificial intelligence (AI) model. The answer generation engine 440 on the communication platform 310 can generate an initial response to the initial query based on the virtual communication data using a first pre-trained generative AI model, generally as described in FIG. 4. The answer model training module 425 of the model training engine 420 on the communication platform 310 can train a first generative AI model to provide a first pre-trained generative AI model. The first generative AI model can be trained by a set of communication data, which can include virtual communication data collected with informed user consent, mockup communication data, or any suitable internal or external data sources. Question-answer pairs can be created from the set of communication data and labeled by an operator as training output, whereas the set of communication data is training input.

The initial response generated by the answer generation engine 440 can be provided to the user via a GUI of the communication application 470 installed on a client device 340 associated with the user. The user can also provide feedback about the initial response, such as a thumbs up indicating helpful or a thumbs down indicating not helpful. The answer model training module 425 can retrain the first pre-trained generative AI model based on the use feedback periodically.

In some examples, at block 702 the query generation engine 450 on the communication platform 310 generates an initial prompt, instead of a user-typed initial query. For example, when the user joins a video conference 20 minutes late, a chat window can pop up with an initial prompt: do you want a summary of what has been discussed so far? If the user selects yes, the process 700 proceeds to access the virtual communication data (e.g., a transcript of the first 20 minutes of the video conference) generally as described at block 704 and generates a summary of the first 20 minutes of the video conference, generally as described at block 706.

At block 708, the communication platform 310 generates a first set of follow-up queries based on the initial response using a second pre-trained generative AI model. The query generation engine 450 on the communication platform 310 can generate the first set of follow-up queries based on the initial response using a second pre-trained generative AI model, generally as described in FIG. 4. The query model training module 435 can train a second generative AI model to provide the second pre-trained generative AI model. The set of communication data used for training the first generative AI model for answer generation can be used as training input for training the second generative AI model for query generation. The labeled questions from the labeled question-answer pairs for training the first generative AI model for answer generation can be used as training output for training the second generative AI model for query generation.

The answer generation engine 440 can provide the initial response to the query generation engine 450. Alternatively, the query generation engine 450 can access the initial response when the initial response is provided to the user, for example via a GUI of a communication application 470 associated with the user. The first set of follow-up queries generated by the query generation engine 450 can be provided to the user via a GUI of the communication application 470 installed on a client device 340 associated with the user.

At block 710, the communication platform 310 receives a selection of a first follow-up query out of the first set of follow-up queries. The user can select one of the first set of follow-up queries as the first follow-up query after the initial response to the initial user query, for example via a GUI of the communication application 470. The communication platform 310 can receive the user selection via the GUI of the communication application 470. Alternatively, the user may request the communication platform 310 to regenerate additional queries. Still alternatively, the user can type in a first follow-up query different from the one or more follow-up queries generated by the query generation engine 450. The user selection or non-selection of the follow-up queries generated by the query generation engine 450 can be feedback to the second pre-trained generative AI model. The query model training module 435 can retrain the second pre-trained generative AI model for query generation.

At block 712, the communication platform 310 provides a first response to the first follow-up query using the first pre-trained generative AI model. The answer generation engine 440 can generate the first response to the first follow-up query using the first pre-trained generative AI model, generally as described in FIG. 3 or at block 706. Following the first response, the query generation engine 450 can generate a second set of follow-up queries based on the first response to the first follow-up query for the user to select. If a user selects a second follow-up query from the second set of follow-up queries or types in the second follow-up query, the answer generation engine 440 can generate a response to the second follow-up query. This way, the user can interact with the communication platform to obtain the relevant information about the virtual communication session.

The example process 700 illustrates a method for interactive query facilitation. However, not every step in the example process 700 may be needed, or some steps may be in a different order. For example, the step at block 704 of accessing virtual communication data associated with a virtual communication session can be performed before the step at block 702 of receiving an initial query about the virtual communication session. The example process 700 is performed by a communication platform 310. Alternatively, the example process 700 can be performed by a communication application 470 installed on a client device 340.

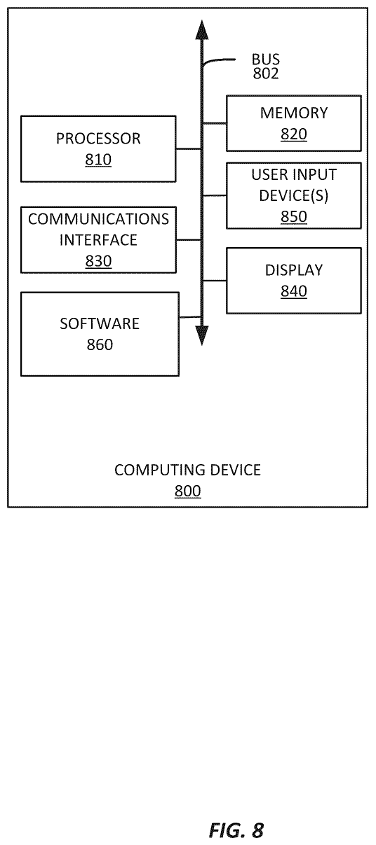

Now referring to FIG. 8, FIG. 8 shows an example computing device 800 suitable for use in example systems or methods for interactive query facilitation. The example computing device 800 includes a processor 810 which is in communication with the memory 820 and other components of the computing device 800 using one or more communications buses 802. The processor 810 is configured to execute processor-executable instructions stored in the memory 820 to perform one or more methods for interactive query facilitation, such as part or all of the example method 700, described above with respect to FIG. 7. The computing device, in this example, also includes one or more user input devices 850, such as a keyboard, mouse, touchscreen, video input device (e.g., one or more cameras), microphone, etc., to accept user input. The computing device 800 also includes a display 840 to provide visual output to a user. The computing device 800 may also include a software 860. The software 860 may include a communication application (client application), a communication platform, and any other software to enable communication from a first user to a second user.

The computing device 800 also includes a communications interface 830. In some examples, the communications interface 830 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
receiving an initial query about a virtual communication session from a user;
accessing virtual communication data associated with the virtual communication session;
generating an initial response to the initial query based on the virtual communication data using a first pre-trained generative artificial intelligence (AI) model;
generating a first set of follow-up queries based on the initial response using a second pre-trained generative AI model;
receiving a selection of a first follow-up query out of the first set of follow-up queries; and
providing a first response to the first follow-up query using the first pre-trained generative AI model.

2. The method of claim 1, wherein the virtual communication session is an online chat session, and wherein the virtual communication data comprises multiple chat messages in the online chat session.

3. The method of claim 1, wherein the virtual communication session is a virtual conference, and wherein the virtual communication data comprises a transcript for the virtual conference.

4. The method of claim 1, wherein the virtual communication session is an email thread, and wherein the virtual communication data comprises a sequence of emails.

5. The method of claim 1, further comprising:
prior to receiving an initial query about the virtual communication session from a user,
training a first generative AI model to obtain the first pre-trained generative AI model using a set of question-answer pairs as a first set of training output and a set of communication data as a first set of training input; and
training a second generative AI model to obtain the second pre-trained generative AI model using a sequence of questions as a second set of training output and the set of communication data as a second set of training input.

6. The method of claim 1, further comprising:
providing the initial response to the user; and
providing the initial response to the second pre-trained generative AI model.

7. The method of claim 1, further comprising:
receiving user feedback about the first set of follow-up queries; and
retraining the second pre-trained generative AI model based on the user feedback to obtain a second retrained generative AI model; and
regenerating the first set of follow-up queries using the second retrained generative AI model.

8. The method of claim 1, further comprising:
receiving a follow-up query created by the user; and
generating an answer to the follow-up query using the first pre-trained generative AI model.

9. The method of claim 1, further comprising:
generating a second set of follow-up queries based on the first response using the second pre-trained generative AI model; and
receiving a selection of a second follow-up query out of the second set of follow-up queries; and
providing a second response to the second follow-up query using the first pre-trained generative AI model.

10. A system comprising:
a communications interface;
a non-transitory computer-readable medium; and
one or more processors communicatively coupled to the communications interface and the non-transitory computer-readable medium, the one or more processors configured to execute processor-executable instructions stored in the non-transitory computer-readable medium to:
receive an initial query about a virtual communication session from a user;
access virtual communication data associated with the virtual communication session;
generate an initial response to the initial query based on the virtual communication data using a first pre-trained generative artificial intelligence (AI) model;
generate a first set of follow-up queries based on the initial response using a second pre-trained generative AI model;
receive a selection of a first follow-up query out of the first set of follow-up queries; and
provide a first response to the first follow-up query using the first pre-trained generative AI model.

11. The system of claim 10, wherein the one or more processors are configured to execute further processor-executable instructions stored in the non-transitory computer-readable medium to:
prior to receiving an initial query about the virtual communication session from a user,
train a first generative AI model to obtain the first pre-trained generative AI model using a set of question-answer pairs as a first set of training output and a set of communication data as a first set of training input; and
train a second generative AI model to obtain the second pre-trained generative AI model using a sequence of questions as a second set of training output and the set of communication data as a second set of training input.

12. The system of claim 10, wherein the one or more processors are configured to execute further processor-executable instructions stored in the non-transitory computer-readable medium to:
provide the initial response to the user; and
provide the initial response to the second pre-trained generative AI model.

13. The system of claim 10, wherein the one or more processors are configured to execute further processor-executable instructions stored in the non-transitory computer-readable medium to:
receive user feedback about the first set of follow-up queries; and
retrain the second pre-trained generative AI model based on the user feedback to obtain a second retrained generative AI model; and
regenerate the first set of follow-up queries using the second retrained generative AI model.

14. The system of claim 10, wherein the one or more processors are configured to execute further processor-executable instructions stored in the non-transitory computer-readable medium to:
receive a follow-up query created by the user; and
generate an answer to the follow-up query using the first pre-trained generative AI model.

15. The system of claim 10, further comprising:
generating a second set of follow-up queries based on the first response using the second pre-trained generative AI model; and
receiving a selection of a second follow-up query out of the second set of follow-up queries; and
providing a second response to the second follow-up query using the first pre-trained generative AI model.

16. A non-transitory computer-readable medium comprising processor-executable instructions configured to cause one or more processors to:
receive an initial query about a virtual communication session from a user;
access virtual communication data associated with the virtual communication session;
generate an initial response to the initial query based on the virtual communication data using a first pre-trained generative artificial intelligence (AI) model;
generate a first set of follow-up queries based on the initial response using a second pre-trained generative AI model;
receive a selection of a first follow-up query out of the first set of follow-up queries; and
provide a first response to the first follow-up query using the first pre-trained generative AI model.

17. The non-transitory computer-readable medium of claim 16, further comprising processor-executable instructions configured to cause one or more processors to:
prior to receiving an initial query about the virtual communication session from a user,
train a first generative AI model to obtain the first pre-trained generative AI model using a set of question-answer pairs as a first set of training output and a set of communication data as a first set of training input; and
train a second generative AI model to obtain the second pre-trained generative AI model using a sequence of questions as a second set of training output and the set of communication data as a second set of training input.

18. The non-transitory computer-readable medium of claim 16, further comprising processor-executable instructions configured to cause one or more processors to:
provide the initial response to the user; and
provide the initial response to the second pre-trained generative AI model.

19. The non-transitory computer-readable medium of claim 16, further comprising processor-executable instructions configured to cause one or more processors to:
receive user feedback about the first set of follow-up queries; and
retrain the second pre-trained generative AI model based on the user feedback to obtain a second retrained generative AI model; and
regenerate the first set of follow-up queries using the second retrained generative AI model.

20. The non-transitory computer-readable medium of claim 16, further comprising processor-executable instructions configured to cause one or more processors to:
receive a follow-up query created by the user; and
generate an answer to the follow-up query using the first pre-trained generative AI model.
